(19) United States
(12) Patent Application Publication
(10) Pub. No.: US 2026/0164305 A1
(43) Pub. Date: Jun. 11, 2026

(54) NETWORK-MANAGED FIBER AND WIRELESS ACCESS CONVERGED CONNECTIVITY

(71) Applicant: AT&T Intellectual Property I, L.P., Atlanta, GA (US)

(72) Inventors: Rashmi Palamadai, Naperville, IL (US); Yupeng Jia, South Pasadena, CA (US)

(21) Appl. No.: 18/977,894

(22) Filed: Dec. 11, 2024

(51) Int. Cl. H04W 28/08; H04L 47/24

(52) U.S. Cl. CPC H04W 28/0835; H04L 47/24

(57) ABSTRACT

A processing system including at least one processor may obtain network performance information from a converged access device, where the converged access device is capable of a fiber access network connection to a communication network and at least one type of wireless access network connection to the communication network. The processing system may next determine, via a converged service management model in accordance with the network performance information from the converged access device, a network access modality distribution for the converged access device. The processing system may then transmit, to the converged access device, the network access modality distribution for implementation by the converged access device.

The present disclosure relates generally to communication network operations, and more particularly to methods, computer-readable media, and apparatuses for determining a network access modality distribution for a converged access device via a converged service management model in accordance with network performance information from the converged access device and to methods, computer-readable media, and apparatuses for selecting a network access modality distribution for implementation by a converged access device in response to a determination of a network performance level shortcoming.

### BACKGROUND

Network operators are expanding fiber optic-based access network (e.g., fiber access networks) coverage. However, network operators may encounter obstacles such as cost, availability of parts and personnel, time for permitting, distance issues, or other limitations (e.g., temporary or medium-term). Thus, areas may continue to await deployment of fiber-to-the-premises network connectivity. At the same time, demand for high bandwidth, high throughput data communications is ubiquitous, regardless of users’ locations or circumstances.

### SUMMARY

In one example, the present disclosure describes a method, non-transitory computer-readable medium, and apparatus for determining a network access modality distribution for a converged access device via a converged service management model in accordance with network performance information from the converged access device. For instance, a processing system including at least one processor may obtain network performance information from a converged access device, where the converged access device is capable of a fiber access network connection to a communication network and at least one type of wireless access network connection to the communication network. The processing system may next determine, via a converged service management model in accordance with the network performance information from the converged access device, a network access modality distribution for the converged access device. The processing system may then transmit, to the converged access device, the network access modality distribution for implementation by the converged access device.

In addition, in one example, the present disclosure describes a method, non-transitory computer-readable medium, and apparatus for selecting a network access modality distribution for implementation by a converged access device in response to a determination of a network performance level shortcoming. For instance, a processing system including at least one processor of a converged access device may monitor network performance information associated with the converged access device, wherein the converged access device is capable of a fiber access network connection to a communication network and at least one type of wireless access network connection to the communication network. The processing system may further determine a network performance level shortcoming in accordance with the network performance information and may select a network access modality distribution for implementation by the converged access device, in response to the determining of the network performance level shortcoming. The network access modality distribution may include at least a first portion of data traffic of the converged access device being allocated to the fiber access network connection and at least a second portion of the data traffic of the converged access device being allocated to the at least one type of wireless access network connection. The processing system may then transmit to the communication network, an indication of the network access modality distribution that is selected for implementation by the converged access device.

### BRIEF DESCRIPTION OF THE DRAWINGS

The teachings of the present disclosure can be readily understood by considering the following detailed description in conjunction with the accompanying drawings, in which:

FIG. 1 illustrates an example system comprising one or more communication networks related to the present disclosure;

FIG. 2 illustrates a flowchart of an example method for determining a network access modality distribution for a converged access device via a converged service management model in accordance with network performance information from the converged access device;

FIG. 3 illustrates a flowchart of an example method for selecting a network access modality distribution for implementation by a converged access device in response to a determination of a network performance level shortcoming; and

FIG. 4 illustrates a high level block diagram of a computing device specifically programmed to perform the steps, functions, blocks and/or operations described herein.

To facilitate understanding, identical reference numerals have been used, where possible, to designate identical elements that are common to the figures.

### DETAILED DESCRIPTION

Examples of the present disclosure include methods, non-transitory computer-readable media, and apparatuses for determining a network access modality distribution for a converged access device via a converged service management model in accordance with network performance information from the converged access device, as well as methods, non-transitory computer-readable media, and apparatuses for selecting a network access modality distribution for implementation by a converged access device in response to a determination of a network performance level shortcoming. For instance, network operators are expanding fiber optic-based access network (e.g., fiber access networks) coverage. However, network operators may encounter obstacles such as cost, availability of parts and personnel, time for permitting, distance issues, or other limitations (e.g., temporary or medium-term). In this regard, examples of the present disclosure enable a combination of fiber and cellular access services to be built out to meet network access/connectivity demands. In particular, examples of the present disclosure provide an intelligent selection of a network access modality distribution via a converged access device. For instance, a converged access device may be capable of a fiber access network connection to a communication network and at least one type of wireless access network connection to the communication network, such as cellular or fixed wireless broadband (FWB) connection. In addition, in one example, artificial intelligence (AI) and/or machine learning (ML)-based processes in the network and/or on a converged access device at a subscriber premises may be used to optimize the interworking between wireline and wireless connectivity based on actual or predicted traffic patterns.

To further illustrate, examples of the present disclosure may enable provisioning of a fiber-level service for “last mile” and “edge” subscriber premises, e.g., without full fiber-to-the-premises buildout. Thus, a network operator may fulfill fiber-level service commitments in strategic manner by permitting the selection of when and what to develop, e.g., fiber, cellular, and/or fixed wireless broadband (FWB) for each location/market. In one example, the present disclosure may include femto-cells, small-cells, or the like at strategic locations to enable selective offering of additional bandwidth (and/or lower the latency for uplink communications, etc.). In one example, a network-based controller may make individual decisions for customer premises having a converged access device to split traffic and/or to steer traffic to one or several access modalities. In one example, the decision making process may account for traffic and/or predicted demand for an area in which a particular converged access device is located (e.g., collectively for subscriber premises connected to a same fiber access node, or the like).

In various examples the present disclosure may use rule-based thresholding and/or AI/ML processes/applications for real-time assessment and decision making. For instance, the present disclosure may forecast/predict demand in a relevant portion of the network based on past/current usage. Along with the actual or forecast demand/utilization, the present disclosure may further account for capacity (e.g., bandwidth availability), latency, throughput, signal strength, signal-to-noise ratio, attenuation, or other network performance indicators, as well as learned customer behavior to drive intelligent selection of a network access modality distribution. To further illustrate, in one example, the present disclosure may provide a bandwidth increase or other network “boost” via a converged access device in response to a spike in demand at the subscriber premises.

In one example, a converged access device may analyze usage/quality of service (broadly network performance information) and may send an alert to a communication network-based monitoring system when one or more network performance indicator thresholds are not met. For example, the converged access device may notify the network when a service level agreement is not met or is forecast/predicted to not be met. In one example, the converged access device and/or the network-based monitoring system may further track network performance by the type of network traffic/activity, the application, and/or the type of application (e.g., uplink versus downlink, web browsing versus gaming, voice calling, etc.), which may be included as part of the alert. In one example, a converged access device may dynamically activate a wireless (e.g., non-fiber) access network connection to aggregate with a fiber access network connection to meet one or more network performance criteria. In one example, this may extend the fiber broadband service footprint (e.g., ensuring fiber-level service) for edge cases, etc. It should also be noted that a converged access device may be further configured to switch over to a cellular service, a FWB service, or a similar wireless service when a fiber access network/fiber access network connection is not functioning. In one example, a network-based monitoring system may continue to collect network performance data to assess and switch back as appropriate.

In one particular example, a subscriber premises may have a converged access device via which both fiber access network and cellular/radio access network services are available. In an area in which fiber-access network services continue to be rolled-out, a network operator may designate certain subscriber premises, e.g., with converged access devices, for particular network thresholds, quality of service (QoS), service level agreements (SLAs), or the like, where these converged access devices/customer premises may have dedicated spectrum and/or other network resources pre-assigned/planned for obtaining service level boosts when needed. In particular, the last subscriber premises of a fiber run, or a cable run from a neighborhood fiber node may generally experience the weakest signals while still remaining within spec for most of the time. Nevertheless, such a premises may possibly experience signal degradation that may impact throughput, usable bandwidth, or the like. As such, in accordance with the present disclosure, additional bandwidth and/or other network access service enhancements may be provided via a signal boost using wireless/non-fiber access (e.g., cellular and/or FWB, or the like). In one example, the present disclosure may extend the solutions described herein to combinations of fiber access network and satellite access network connections, or similar non-fiber/non-wired access technologies. It should also be noted that as referred to herein, a fiber access network may include pure fiber access networks (e.g., FTTP), hybrid fiber access networks, e.g., FTTN, and so forth. Thus, for example, an access network that integrates with a subscriber premises using cable/coaxial, digital subscriber line (DSL), or the like, may also be considered as fiber access networks insofar as these may integrate with a wider carrier communication network via a neighborhood fiber node, a fiber node in a central office (CO), a local data center, or the like.

It should again be noted that fiber may not necessarily be available to support the full subscriber requirements/demands in an area. However, using examples of the present disclosure, a network operator may share distribute fiber/wired access traffic load between cellular and/or fixed wireless services that may be available in the area or that may be more easily deployed to an area until full fiber access coverage is able to be provided, where the network operator may utilize customized strategies to accommodate subscriber service demands. Thus, a network operator may use different combinations of available network technologies to support subscribers having converged access devices. In addition, other subscribers in a same area may indirectly benefit from intelligent management of network traffic for customer premises having such converged access devices. In one example, software defined network (SDN) principles may be applied via the network-based monitoring system to adjust traffic flow and to optimize resource utilization between fiber and wireless at the “last mile.” In various cases, converged access technologies may be used as either temporary or permanent solutions, e.g., depending upon the feasibility, cost, community opposition or support, the demand level versus the capacity of different solutions or different combinations of access solutions, and so forth. In addition, depending on throughput demands, the issue of distance attenuation can be addressed using capacity boost from femto-cells/small-cells, such that an additional fiber-level service past the “grid limit” can be obtained.

Based on the location/market and/or type of subscriber, a network operator may plan for network resource allocation at specific days/times for FTTN neighborhoods. For instance, the network operator may obtain data feeds indicating likely increases in data traffic demands, such as specific sporting events based on market and locations (e.g., pay-per-view fights, championship games, etc.). In one example AI/ML-based forecasting/prediction models may be trained using past observations to forecast/predict demand at specific times of the day, days of the week, times of year, e.g., holidays, and so forth. In one example, a real-time analysis may be used in conjunction with forecasting/prediction to adjust or confirm allocations of network resources.

In one example, a converged access device may dynamically monitor devices and usage within a home or other subscriber premises. When performance indicator (e.g., “key performance indicator” (KPI))/service level agreement (SLA) thresholds are impacted, the converged access device may send an alert to a network based monitoring system. In particular, the converged access device may assess a network traffic demand of the premises, such as based on the type of activity (e.g., downlink, uplink, voice, video streaming, video calling, gaming, etc.) and may request additional network resources (additional bandwidth/reduced latency) on the basis of the assessed demand (e.g., actual or forecast/predicted). The network-based monitoring system and the converged access device may maintain two-way communication to assess and to switch the network access modality distribution (e.g., a combination of fiber and wireless/non-fiber access) as appropriate.

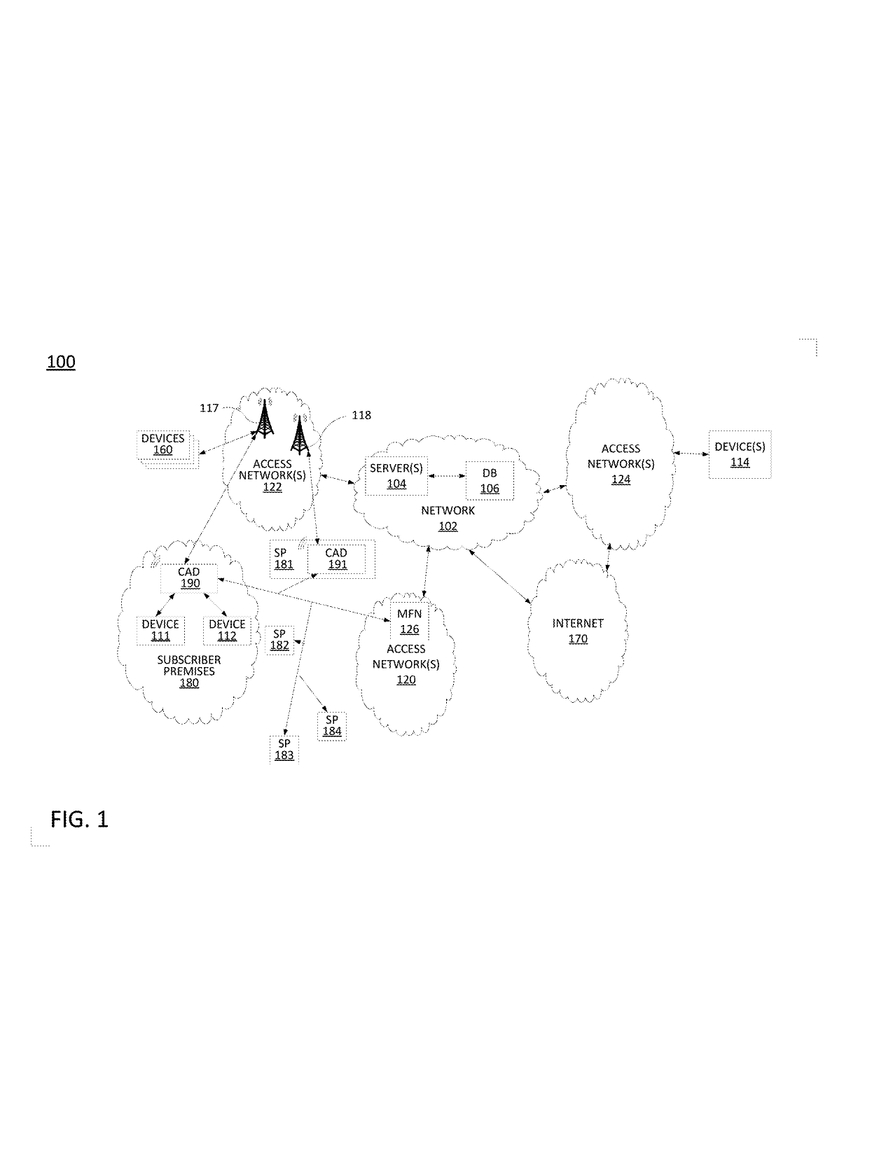

Thus, examples of the present disclosure may expand fiber-level service at minimal cost and on an expedited basis. In particular, wireless boosting of network capability to serve subscribers having fiber/wired access services when a need/demand arises as defined by the user and/or through predictive analytics. In addition, examples of the present disclosure provide a more consistent user experience for subscribers/subscriber premises (such as those with FTTN installations versus FTTP installations) via the intelligent selection of network access modality distributions, e.g., by a network-based monitoring system. Furthermore, examples of the present disclosure may help ensure uninterrupted connectivity, may enhance the coverage/footprint of high-speed fiber broadband connectivity, and may also increase the broadband connectivity capacity. In one particular example, the present disclosure also overcomes problems of distance and attenuation for subscribers/subscriber premises towards the end of a fiber/wired access run, e.g., until new/additional fiber nodes may be installed via which such premises can be served with a shorter run, or the like. These and other aspects of the present disclosure are described in greater detail below in connection with the examples of FIGS. 1-4.

To further aid in understanding the present disclosure, FIG. 1 illustrates an example system 100 in which examples of the present disclosure may operate. The system 100 may include any one or more types of communication networks, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, 4G, 5G and the like), a long term evolution (LTE) network, and the like, related to the current disclosure. It should be noted that an IP network is broadly defined as a network that uses Internet Protocol to exchange data packets. Additional example IP networks include Voice over IP (VoIP) networks, Service over IP (SoIP) networks, and the like.

In one example, the system 100 may comprise a network 102 (e.g., a communication network of a communication service provider, e.g., a carrier network). The network 102 may be in communication with one or more access networks 120, 122, and 124, and the Internet (not shown). In one example, network 102 may combine core network components of a cellular network with components of a triple-play service network; where triple-play services include telephone services, Internet services and television services to subscribers. For example, network 102 may functionally comprise a fixed mobile convergence (FMC) network, e.g., an IP Multimedia Subsystem (IMS) network. In addition, network 102 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Network 102 may further comprise a broadcast television network, e.g., a traditional cable provider network or an Internet Protocol Television (IPTV) network, as well as an Internet Service Provider (ISP) network. In one example, network 102 may include a plurality of television (TV) servers (e.g., a broadcast server, a cable head-end), a plurality of content servers, an advertising server (AS), an interactive TV/video-on-demand (VoD) server, and so forth. For ease of illustration, various additional elements of network 102 are omitted from FIG. 1.

In one example, the access networks 120 may comprise wired access networks, e.g., fiber-optic access networks (or fiber access networks), cable access networks, Digital Subscriber Line (DSL) access networks, or the like. In one example, the access networks 120 may comprise different types of access networks, may comprise the same type of access network, or some access networks may be the same type of access network and other may be different types of access networks. Access networks 122 may comprise a cellular radio access network (RAN) in accordance with any “second generation” (2G), “third generation” (3G), “fourth generation” (4G), Long Term Evolution (LTE), “fifth generation” (5G), or any other existing or yet to be developed future wireless/cellular network technology. While the present disclosure is not limited to any particular type of wireless access network, in the illustrative example, base stations 117 and 118 may each comprise a Node B, evolved Node B (eNodeB), or gNodeB (gNB), or any combination thereof providing a multi-generational/multi-technology-capable base station. In one example, the access networks 122 may include a fixed wireless broadband (FWB) access network. In one example, the access networks 122 may comprise different types of wireless access networks, may comprise the same type of wireless access network, or some wireless access networks may be the same type of wireless access network and other may be different types of wireless access networks. In one example, the network 102 may be operated by a communication network service provider. The network 102 and the access networks 120 and 122 may be operated by the same service provider.

In one example, the access networks 120 may be in communication with one or more devices of various subscriber premises (SP) 180-184. Each of the subscriber premises 180-184 may have a respective customer premises equipment (CPE), e.g., an access device, such as an optical networking unit (ONU) and/or an optical network terminal (ONT), a fixed-wireless broadband (FWB) node, a gateway, and so forth. In accordance with the present disclosure, such CPE may further include converged access devices (CADs), such as CAD 190 of subscriber premises 180, CAD 191 of subscriber premises 181, etc. As noted above, a CAD may combine fiber access and wireless/cellular access capabilities for a single customer premises. For instance, CAD 190 and CAD 191 may each comprise an ONU/ONT integrated with a cellular and/or FWB access point. In other examples, CAD 190 and/or CAD 191 may comprise a cable modem or the like integrated with a cellular and/or FWB access point. For instance, subscriber premises 180 may have FTTN wired/optical network access (or hybrid fiber-coaxial network access) via CAD 190 and wireless access via access network 120, e.g., where the last mile may comprise coaxial. For instance, access network 120 may include a mini-fiber node (MFN) 126, which may alternatively or additionally comprise a video ready access device (VRAD), and so forth. In various examples, the MFN 126 may support FTTP installations and/or FTTN/HFC installations. Continuing with the present example, subscriber premises 180 may have a plurality of endpoint devices, such as devices 111 and 112, which may obtain various communication services via CAD 190, e.g., data/internet, telephone/voice, video/television, etc. For instance, devices 111 and 112 may comprise desktop computers, laptop computers, televisions, set-top boxes (STBs), digital video recorders (DVRs), biometric devices/wearable computing devices, sensor devices, smart appliances, etc., as well as wired and wireless routers, switches, etc. For instance, each of the SPs 180-184 may comprise a local area network (LAN) of a home, enterprise, educational or medial institution, and so forth.

Access network(s) 122 may provide cellular and/or FWB service to various endpoint devices and/or other cellular access devices. For instance, access network(s) 120 may provide cellular/wireless access service to devices 160, which may comprise cellular telephones, e.g., mobile smartphones, etc., cellular enabled laptop computers, tablet computing devices, wearable computing devices, such as smart watches, augmented reality devices, e.g., smart glasses, and so forth. In accordance with the present disclosure, access network(s) 122 may also provide cellular/wireless access service to FWB access devices and/or CADs, such as CADs 190 and 191.

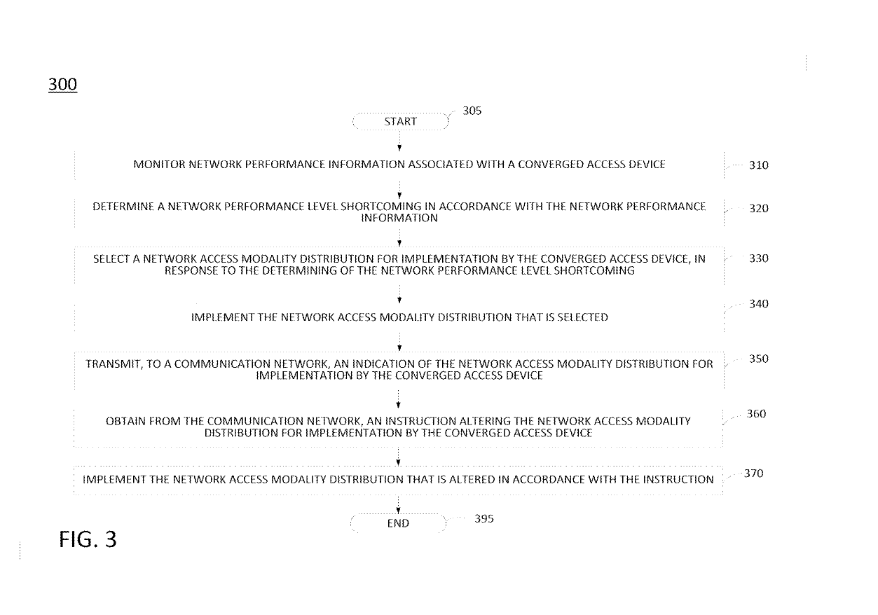

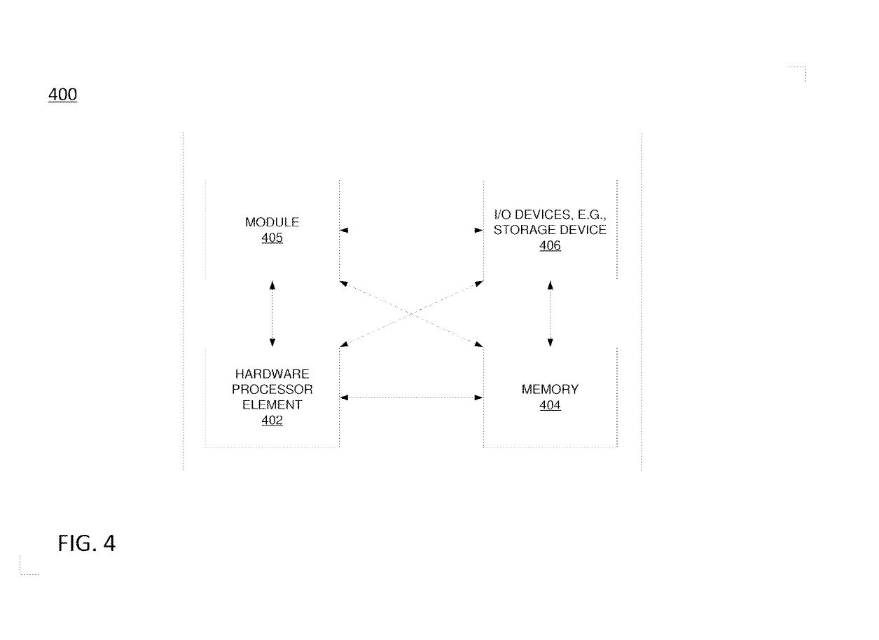

In accordance with the present disclosure, each of the CAD 190 and CAD 191 may comprise a computing system, such as computing system 400 depicted in FIG. 4, and may be configured to provide one or more functions in connection with examples of the present disclosure for selecting a network access modality distribution for implementation by a converged access device in response to a determination of a network performance level shortcoming, such as illustrated in FIG. 3 and described below. In addition, it should be noted that as used herein, the terms “configure,” and “reconfigure” may refer to programming or loading a processing system with computer-readable/computer-executable instructions, code, and/or programs, e.g., in a distributed or non-distributed memory, which when executed by a processor, or processors, of the processing system within a same device or within distributed devices, may cause the processing system to perform various functions. Such terms may also encompass providing variables, data values, tables, objects, or other data structures or the like which may cause a processing system executing computer-readable instructions, code, and/or programs to function differently depending upon the values of the variables or other data structures that are provided. As referred to herein a “processing system” may comprise a computing device, or computing system, including one or more processors, or cores (e.g., as illustrated in FIG. 4 and discussed below) or multiple computing devices collectively configured to perform various steps, functions, and/or operations in accordance with the present disclosure.

Access network(s) 124 may comprise access networks of a same or similar configuration as any one or more of access network(s) 120 and/or access network(s) 122, such as fiber access networks, cable access networks, HFC access networks, cellular and/or FBW access networks, and so forth. In one example, one or more of the access networks 120 and 122 may be operated by the same network operator as network 102. In other words, network 102, access network(s) 120, and access network(s) 122 may comprise a carrier communication network of a single network operator/carrier. In one example, access network(s) 124 may also be operated by the same network operator. In another example, access network(s) 124 may be operated by a different network operator. Access network(s) 124 may provide wired and/or wireless network service to various devices 114, which may comprise cellular access devices, personal computers, laptop computer, tablet computing devices, sensor devices, augmented reality devices, and so forth. In one example, the network 102, access network 120, and access network 122 may link one or more SPs 180-184 and the endpoint devices thereof with each other and with Internet 170, access network(s) 124 and the endpoint devices thereof (e.g., devices 114), and so on.

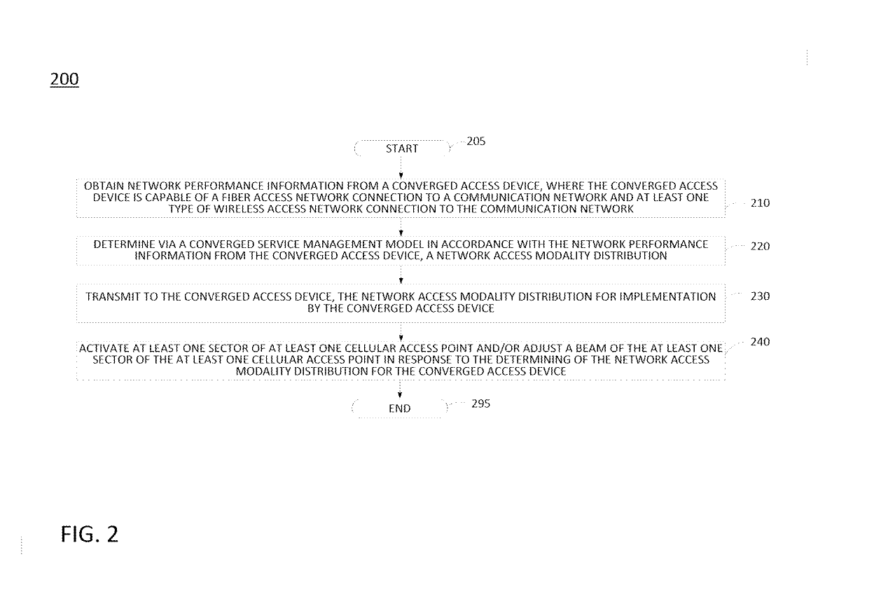

As further illustrated in FIG. 1, network 102 may include server(s) 104, which may each comprise a computing system or server, such as computing system 400 depicted in FIG. 4, and may be configured to provide one or more operations or functions in connection with examples of the present disclosure for determining a network access modality distribution for a converged access device via a converged service management model in accordance with network performance information from the converged access device, e.g., as described in connection with FIG. 2. For instance, server(s) 104 may provide a network-based monitoring system (e.g., a subscriber premises monitoring and management system) in accordance with the present disclosure. In one example, database(s) 106 may represent one or more centralized or distributed file systems, e.g., a Hadoop® Distributed File System (HDFS^{TM}), or the like. Server(s) 104 may receive and store information in database(s) 106 relating to different subscriber premises, different access devices, e.g., CADs, ONUs/ONTs, cable modems, etc., different endpoint devices, and so forth. For instance, in one example, server(s) 104 may establish communications with CADs 190 and 191 periodically or on another basis to obtain and update all or a subset of the information maintained in database(s) 106 relating to the subscriber premises 180 and 181 (and similarly with regard to premises 182-184, etc.). To further illustrate, database(s) 106 may collect and store network performance information relating to subscriber premises 180-184. For instance, the network performance information may comprise a data traffic demand (or the data traffic demand is predicted from the network performance information). For instance, the network performance information may include past data utilization metrics for uplink and/or downlink, for different data types and/or different applications or application types, etc., the number of connected devices (e.g., at different times of the day, days of the week, etc., which may be used for forecasting future demand at similar times of the day, days of the week, etc.), and so forth.

In accordance with the present disclosure, server(s) 104 may select network access modality distributions for implementation by converged access devices, such as CADs 190 and 191. For instance, server(s) 104 may implement a converged service management model on a subscriber premises-basis and/or across a plurality of subscriber premises, such as in a neighborhood, e.g., from a same fiber distribution hub, from a same fiber access terminal (such as MFN 126), etc. For each CAD/subscriber premises, the network access modality distributions may comprise utilizations of both the fiber access network connection and the at least one type of wireless access network connection. For instance, a network access modality distribution may comprise a first percentage of data traffic of the CAD to be allocated to the fiber access network connection and a second percentage of the data traffic of the CAD to be allocated to the at least one type of wireless access network connection, a first type of data traffic of the CAD to be allocated to the fiber access network connection and a second type of data traffic of the CAD to be allocated to the at least one type of wireless access network connection, etc. For instance, audio and video may be split, gaming visual data and audio may be split, gaming and video traffic may be split from voice call traffic, web browsing, etc., in other words, data traffic for different applications may be split, and so forth. Alternatively or additionally, uplink and downlink may be split.

In one example, the converged service management model may comprise a rule set that indicates a method to allocate all data traffic of the converged access device to the fiber access network connection when a data traffic demand of the converged access device is at or below a threshold, and to allocate a first percentage of the data traffic of the converged access device to the fiber access network connection and a second percentage of the data traffic of the converged access device to the at least one type of wireless access network connection when the data traffic demand of the converged access device is at or above the threshold. For instance, the threshold may be set based upon at least one of: a distance of the converged access device from a fiber access node (e.g., based on attenuation and/or distance) and/or a data traffic demand of other subscriber premises sharing a same fiber access network associated with the fiber access network connection of the converged access device. Alternatively, or in addition, the converged service management model may comprise a rule set that indicates a method to allocate all data traffic of the converged access device to the fiber access network connection when a data traffic demand of the converged access device is at or below a threshold, and to allocate a first type of data traffic of the converged access device to the fiber access network connection and a second type of data traffic of the converged access device to the at least one type of wireless access network connection when the data traffic demand of the converged access device is at or above the threshold. As in the preceding example, the threshold may be set based upon at least one of: a distance of the converged access device from a fiber access node (e.g., based on attenuation and/or distance) and/or a data traffic demand of other subscriber premises sharing a same fiber access network associated with the fiber access network connection of the converged access device.

In one example, the converged service management model may comprise a machine learning model (MLM) that is configured to generate an output comprising the network access modality distribution for the converged access device in response to an input vector comprising at least the network performance information from the converged access device. In one example, the input vector may further include network performance information from other subscriber premises sharing a same fiber access network associated with the fiber access network connection of the converged access device. These can include other subscriber premises with their own converged access devices, or other subscriber premises which may have a fiber-only access type available. For instance, the MLM may take into consideration an overall aggregate demand or forecast demand to determine how to handle the converged access device. In one example, the input vector may further include one or more of: a time of day, a day of the week, an indicator of a holiday, an indicator of a mass gathering event associated with an area of the converged access device, etc.

In this regard, it should be noted that in one example, server(s) 104, a subscriber premises monitoring and management system, may comprise one or more machine learning algorithms (MLAs), e.g., one or more trained machine learning models (MLMs). For instance, a machine learning algorithm (MLA), or machine learning model (MLM) trained via a MLA may be for selecting a network access modality distribution, for forecasting/prediction that a SLA may not be met, and/or for other tasks in accordance with the present disclosure. For instance, the MLA (or the trained MLM) may comprise a deep learning neural network, or deep neural network (DNN), such as convolutional neural network (CNN), a generative adversarial network (GAN), a language model, or “large language model” (LLM) such as a bidirectional encoder representations from transformers (BERT) model (e.g., BERT-Base, BERT-Large, etc.), a generative pre-training (GPT) model (e.g. GPT, GPT-2, GPT-3, or the like), a semantic graphs-based pre-training (SGPT) model, or other generative natural language processing (NLP) models, a support vector machine (SVM), e.g., a binary, non-binary, or multi-class classifier, a linear or non-linear classifier, and so forth. In one example, the MLA may incorporate an exponential smoothing algorithm (such as double exponential smoothing, triple exponential smoothing, e.g., Holt-Winters smoothing, and so forth), reinforcement learning (e.g., using positive and negative examples after deployment as a MLM), and so forth. It should be noted that various other types of MLAs and/or MLMs may be implemented in examples of the present disclosure, such as k-means clustering and/or k-nearest neighbor (KNN) predictive models, support vector machine (SVM)-based classifiers, e.g., a binary classifier and/or a linear binary classifier, a multi-class classifier, a kernel-based SVM, etc., a distance-based classifier, e.g., a Euclidean distance-based classifier, or the like, and so on.

In one example, for forecasting/prediction tasks, the present disclosure may train and apply one or more time series prediction/forecasting models (e.g., AI/ML models) based upon historical network performance information of a particular subscriber premises and/or CAD, or across a plurality of subscriber premises. For instance, the time series prediction/forecasting model may comprise a moving average (MA) model, an autoregressive distributed lag (ADL) model, an autoregressive integrated moving average (ARIMA) model, a seasonal ARIMA (SARIMA) model, or the like. Similarly, other regression-based models may be trained and used for such prediction/forecasting, such as logistic regression, polynomial regression, ridge regression, lasso regression, etc. In one example, the present disclosure may predict/forecast using multiple factors as predictors (e.g., covariates, or exogenous factors). For instance, a seasonal auto-regressive integrated moving average with exogenous factors (SARIMAX) model may be used. Alternatively, a vector auto-regression (VAR), or VAR moving average (VARMA) model may be used. Similarly, a vector auto-regression moving-average with exogenous factors/regressors (VARMAX) model may be applied. For instance, as described above, an input vector may include a time of day, a day of the week, an indicator of a holiday, an indicator of a mass gathering event associated with an area of the converged access device, etc.

In one example, network performance information may be stored by DB(s) 106 and used by server(s) 104 to train and implement one or more of such models, and/or to update such models via reinforcement learning (RL), via ongoing observations and retraining, or the like. In one example, the converged service management model may comprise a first MLM to detect whether a SLA may fail to be met based on the network performance information, and a rule set and/or another MLM to select the response (e.g., the network access modality distribution when the condition of failing to meet the SLA is determined). Collectively, these functionalities may be considered an AI model and/or a MLM, e.g., a converged service management model comprising an ensemble MLM, a MLM pipeline, etc. In one example, the response may be particularized to the service agreement associated with the converged access device.

Thus, in one example, server(s) 104 may receive network performance data from SPs 180-184 and may process the network performance data (and in some examples data of other co-factors, etc.) to determine that a SLA may not be met for SP 180/CAD 190. In addition, server(s) 104 may determine, in accordance with the converged service management model, a network access modality distribution for the CAD 190. In addition, server(s) 104 may transmit to CAD 190 the network access modality distribution for implementation by the CAD 190. In one example, server(s) 104 may further configure/reconfigure aspects of the communication network (e.g., network 102, access network(s) 120 and/or 122, etc.) to support the network access modality distribution for the CAD 190 and/or for a plurality of subscriber premises. For instance, CAD 190/subscriber premises 180 and CAD 191/subscriber premises 181 may be similarly configured at a same time. To illustrate, server(s) 104 may activate a femto-cell, small-cell, or the like in a vicinity of CAD 190 and/or CAD 191 (e.g., within wireless communication range with above a threshold signal-to-noise ratio or the like), may adjust a beam of a base station and/or sector, e.g., in azimuth and/or elevation, with respect to beamwidth, or the like, for uplink footprint, downlink footprint, or both, and so forth. These and other aspects of the present disclosure for determining a network access modality distribution for a converged access device via a converged service management model in accordance with network performance information from the converged access device are illustrated in the example method 200 of FIG. 2 and further described below.

In one example, MLM(s) for selecting a network access modality distribution and/or for forecasting/prediction that a SLA may not be met may be trained at the network-based processing system (e.g., server(s) 104, or the like) and implemented therein. Alternatively, or in addition, MLM(s) for selecting a network access modality distribution and/or for forecasting/prediction that a SLA may not be met may be deployed and implemented by a CAD, such as CAD 190 and/or CAD 191. For instance, CAD 190 may implement a same or similar converged service management model such as described above (e.g., comprising a rule set and/or one or more MLMs for selecting a network access modality distribution and/or for forecasting/prediction that a SLA may not be met). In one example, the converged service management model and/or aspects thereof may be trained via CAD 190 itself. Alternatively, or in addition, the converged service management model and/or aspects thereof may be trained at a network-based system (such as server(s) 104) and deployed to CAD 190 (and similarly for CAD 191, etc.).

Thus, for instance, in one example, CAD 190 may monitor network performance information associated with CAD 190/premises 180 to determine a network performance level shortcoming in accordance with the network performance information (e.g., an actual or forecast/predicted SLA failure/shortcoming). For example, the converged access device may determine that it has or will have a spike in demand due to VR gaming or the like. It may then determine on its own whether fiber access alone may meet the demand or whether, given the state of the fiber access network across the entire neighborhood, it may be best to use a non-fiber access modality in addition to the fiber access network connection. Accordingly, CAD 190 may further select a network access modality distribution for implementation by CAD 190, in response to the determining of the network performance level shortcoming, and may implement the network access modality distribution that is selected. For instance, CAD 190 may transmit and/or receive data via the respective network access modalities. In one example, this may include CAD establishing a wireless network access session, e.g., a radio resource control (RRC) attach procedure to establish a cellular and/or FWB network connection, or the like.

CAD 190 may further transmit to the communication network, e.g., to server(s) 104, the network access modality distribution for implementation CAD 190. In one example, prior to or after implementing the network access modality distribution, CAD 190 may obtain from the communication network, an instruction altering the network access modality distribution for implementation by CAD 190. In such case, CAD 190 may implement the network access modality distribution that is altered in accordance with the instruction. In other words, CAD 190 may select an initial preferred network access modality distribution, where the communication network may approve, deny, or modify the network access modality distribution, e.g., using the same or similar logic as described above with respect to the network-based implementation of a converged service management model. These and other aspects of the present disclosure for selecting a network access modality distribution for implementation by a converged access device in response to a determination of a network performance level shortcoming are illustrated in the example method 300 of FIG. 3 and further described below.

It should be noted that the foregoing are just several examples of the present disclosure for determining a network access modality distribution for a converged access device via a converged service management model in accordance with network performance information from the converged access device and/or for selecting a network access modality distribution for implementation by a converged access device in response to a determination of a network performance level shortcoming. Thus, it should be noted that in other, further, and different examples, aspects described above with respect to particular network elements/network functions may relate to various other network elements/network functions. For instance, in one example, network performance information may alternatively or additional be collected from network probes (e.g., dedicated monitoring elements) or from other network components, such as performance data from MFN 126, base stations 117 and 118, etc., routers, gateways, etc. within network 102, and so forth. Similarly, although server(s) 104 are illustrated as being within network 102, in other examples, aspects described above with respect to server(s) 104 may alternatively or additionally be deployed at the network edge, such as within access network(s) 120 and/or 122, or the like. For instance, a network operator may deploy subscriber premises monitoring and management system on a neighborhood-by-neighborhood basis, or the like. In addition, although examples of FIG. 1 may be applicable to subscriber premises and a neighborhood comprising customers/users’ homes, the present disclosure is broadly applicable to various other types of subscriber premises, such as an office building, an apartment building, a mixed-use building, a campus, a campsite, a public space (which can be indoor or outdoor), a vehicle, such as a ship, a bus, etc., and so forth.

It should also be noted that the system 100 has been simplified. Thus, the system 100 may be implemented in a different form than that which is illustrated in FIG. 1, or may be expanded by including additional endpoint devices, access networks, network elements, application servers, etc. without altering the scope of the present disclosure. In addition, system 100 may be altered to omit various elements, substitute elements for devices that perform the same or similar functions, combine elements that are illustrated as separate devices, and/or implement network elements as functions that are spread across several devices that operate collectively as the respective network elements. In addition, the system 100 may include other network elements (not shown) such as border elements, routers, switches, policy servers, security devices, gateways, a content distribution network (CDN) and the like. For example, portions of network 102 and/or access networks 120 and 122 may comprise a content distribution network (CDN) having ingest servers, edge servers, and the like. Similarly, although only two access networks 120 and 122 are shown, in other examples, access networks 120 and/or 122 may each comprise a plurality of different access networks that may interface with network 102 independently or in a chained manner. Thus, these and other modifications are all contemplated within the scope of the present disclosure.

FIG. 2 illustrates a flowchart of an example method 200 for determining a network access modality distribution for a converged access device via a converged service management model in accordance with network performance information from the converged access device. In one example, the method 200 is performed by a network-based server, or servers, such as server(s) 104 illustrated in FIG. 1, or the like, or any one or more components thereof, or by any one or more of such devices in conjunction with one another and/or in conjunction with other devices and/or components of system 100 of FIG. 1, such as CAD 190, CAD 191, and/or other access devices, etc. In one example, the steps, functions, or operations of method 200 may be performed by a computing device or processing system, such as computing system 400 and/or hardware processor element 402 as described in connection with FIG. 4 below. For instance, the computing system 400 may represent any one or more components of the system 100 that is/are configured to perform the steps, functions and/or operations of the method 200. Similarly, in one example, the steps, functions, or operations of the method 200 may be performed by a processing system comprising one or more computing devices collectively configured to perform various steps, functions, and/or operations of the method 200. For instance, multiple instances of the computing system 400 may collectively function as a processing system. For illustrative purposes, the method 200 is described in greater detail below in connection with an example performed by a processing system. The method 200 begins in step 205 and proceeds to step 210.

At step 210, the processing system obtains network performance information from a converged access device, where the converged access device is capable of a fiber access network connection to a communication network and at least one type of wireless access network connection to the communication network. For instance, the converged access device may be deployed at a subscriber premises. In addition, the at least one type of wireless access network connection may comprise at least one of: a cellular access network connection or a fixed wireless broadband (FWB) connection. In one example, the network performance information may include: past data utilization metrics for uplink and/or downlink, for different data types and/or different applications or application types, etc., the number of connected devices (e.g., at different times of the day, days of the week, etc., which may be used for forecasting future demand at similar times of the day, days of the week, etc.), and so forth. The network performance information may be associated with the converged access device. In one example, the network performance information may be further associated with other subscriber premises. In one example, the network performance information may comprise a data traffic demand associated with the converged access device, and/or associated with a plurality of subscriber premises including a subscriber premises of the converged access device. For instance, the network performance information for other subscriber premises may include the same types of information that can be used to directly indicate a current demand and/or to forecast a future demand for these other subscriber premises (individually and/or collectively). In another example, the processing system may treat demand on an aggregate basis, e.g., tracking overall utilization/demand in a neighborhood and then predicting using the aggregate records as the basis for the forecasting/prediction.

At step 220, the processing system determines via a converged service management model in accordance with the network performance information from the converged access device, a network access modality distribution for the converged access device, e.g., where the network access modality distribution includes utilizations of both the fiber access network connection and the at least one type of wireless access network connection. For instance, as noted above, the converged service management model may comprise a rule set that indicates a method to allocate all data traffic of the converged access device to the fiber access network connection when a data traffic demand of the converged access device is at or below a threshold, and to allocate a first percentage of the data traffic of the converged access device to the fiber access network connection and a second percentage of the data traffic of the converged access device to the at least one type of wireless access network connection when the data traffic demand of the converged access device is at or above the threshold. For instance, the threshold may be set based upon at least one of: a distance of the converged access device from a fiber access node (e.g., based on attenuation and/or distance) and/or a data traffic demand of other subscriber premises sharing a same fiber access network associated with the fiber access network connection of the converged access device. Thus, in one example, the network access modality distribution may include a first percentage of data traffic of the converged access device to be allocated to the fiber access network connection and a second percentage of the data traffic of the converged access device to be allocated to the at least one type of wireless access network connection.

Alternatively, or in addition, the converged service management model may comprise a rule set that indicates a method to allocate all data traffic of the converged access device to the fiber access network connection when a data traffic demand of the converged access device is at or below a threshold, and to allocate a first type of data traffic of the converged access device to the fiber access network connection and a second type of data traffic of the converged access device to the at least one type of wireless access network connection when the data traffic demand of the converged access device is at or above the threshold. As in the preceding example, the threshold may be set based upon at least one of: a distance of the converged access device from a fiber access node (e.g., based on attenuation and/or distance) and/or a data traffic demand of other subscriber premises sharing a same fiber access network associated with the fiber access network connection of the converged access device. Thus, in one example, the network access modality distribution may include a first type of data traffic of the converged access device to be allocated to the fiber access network connection and a second type of data traffic of the converged access device to be allocated to the at least one type of wireless access network connection.

In one example, the converged service management model may comprise a machine learning model (MLM) that is configured to generate an output comprising the network access modality distribution for the converged access device in response to an input vector comprising at least the network performance information from the converged access device. In one example, the input vector may further include network performance information from other subscriber premises sharing a same fiber access network associated with the fiber access network connection of the converged access device. In one example, the input vector may further include one or more of: a time of day, a day of the week, an indicator of a holiday, an indicator of a mass gathering event associated with an area of the converged access device, etc. In one example, step 220 may include predicting a data traffic demand from the network performance information (e.g., if not included as part of the network performance information as collected at step 210).

To further illustrate, in one example, the network performance information may comprise an indication of a predicted demand and/or a prediction that a SLA for the subscriber premises/converged access device will not be met. In other words, the converged access device may have its own prediction/forecasting model(s) to enable it to determine that a likely SLA failure may occur if action is not taken. Then the converged access device may contact the processing system, which can confirm and instruct the converged access device to obtain a portion of the service from the non-fiber access modality as described in subsequent steps. In another example, the network may aggregate network performance data from neighborhood and may determine that the SLA of the converged access device/subscriber premises may not be met, or may determine that the SLA of one or more other subscriber premises may not be met. In other words, in one example, even if the converged access device is not over-utilizing the fiber access network, it may still be directed to allocate at least a portion of the data traffic for the converged access device to the non-fiber access network for alleviating conditions that may affect other subscriber premises.

At step 230, the processing system transmits to the converged access device, the network access modality distribution for implementation by the converged access device. For instance, the processing system and the converged access device may maintain communications on an ongoing basis (e.g., via the wired/fiber access modality or otherwise) to report network performance information, to transmit and receive network access modality distributions for implementation by the converged access device, and so forth.

At optional step 240, the processing system may activate at least one sector of at least one cellular access point (e.g., a femto-cell, a small-cell, etc.) and/or may adjust a beam of the at least one sector of the at least one cellular access point (e.g., a femto-cell, a small-cell, a macro-cell, etc.) in response to the determining of the network access modality distribution for the converged access device, e.g., when it is determined that the second percentage of the data traffic or the second type of data traffic of the converged access device is to be allocated to the at least one type of wireless access network connection, and where the at least one type of wireless access network connection comprises a radio access network (RAN)/cellular access network connection.

Following step 230 or optional step 240, the method 200 may proceed to step 295. At step 295 the method 200 ends.

It should be noted that the method 200 may be expanded to include additional steps, or may be modified to replace steps with different steps, to combine steps, to omit steps, to perform steps in a different order, and so forth. For instance, in one example the processing system may repeat one or more steps of the method 200, such as steps 210-230 or steps 210-240 for the same or a different converged access device, etc. In one example, the method 200 may further include collecting one or more training data sets from the converged access device and/or from a plurality of converged access devices (e.g., in a same neighborhood, or the like), and training one or more machine learning models as described above using the training data set(s). In one example, the method 200 may be expanded or modified to include steps, functions, and/or operations, or other features described above in connection with the example(s) of FIG. 1 and/or FIG. 3, or as described elsewhere herein. Thus, these and other modifications are all contemplated within the scope of the present disclosure.

FIG. 3 illustrates a flowchart of an example method 300 for selecting a network access modality distribution for implementation by a converged access device in response to a determination of a network performance level shortcoming. In one example, the method 300 is performed by a converge access device, such as CAD 190 illustrated in FIG. 1, or the like, or any one or more components thereof, or by a CAD in conjunction with other CADs and/or in conjunction with other devices and/or components of system 100 of FIG. 1, such as server(s) 104. In one example, the steps, functions, or operations of method 300 may be performed by a computing device or processing system, such as computing system 400 and/or hardware processor element 402 as described in connection with FIG. 4 below. For instance, the computing system 400 may represent any one or more components of the system 100 that is/are configured to perform the steps, functions and/or operations of the method 300 (e.g., a CAD). Similarly, in one example, the steps, functions, or operations of the method 300 may be performed by a processing system comprising one or more computing devices collectively configured to perform various steps, functions, and/or operations of the method 300. For instance, multiple instances of the computing system 400 may collectively function as a processing system. For illustrative purposes, the method 300 is described in greater detail below in connection with an example performed by a processing system. The method 300 begins in step 305 and proceeds to step 310.

At step 310, the processing system, e.g., of a converged access device, may monitor network performance information associated with the converged access device. For example, the processing system may collect network performance information such as described above, e.g., past data utilization metrics for uplink and/or downlink, for different data types and/or different applications or application types, etc., the number of connected devices (e.g., at different times of the day, days of the week, etc., which may be used for forecasting future demand at similar times of the day, days of the week, etc.), and so forth. In one example, step 310 may also include collecting additional network performance information from other subscriber premises sharing a same fiber access network associated with the fiber access network connection of the converged access device, which could be aggregated/anonymized. For instance, this type of information may be collected directly from such other subscriber premises and/or from a network-based premises management and monitoring system. As noted above, the converged access device may be capable of a fiber access network connection to a communication network and at least one type of wireless access network connection to the communication network. In one example, the network performance information may be for the fiber access network connection to a communication network, e.g., when the converged access device is currently using the fiber access network connection.

At step 320, the processing system determines a network performance level shortcoming in accordance with the network performance information (e.g., an actual or forecast/predicted SLA failure/shortcoming). For example, the processing system of the converged access device may determine that it has or will have a spike in demand due to VR gaming or the like in a future time period. It may then determine whether fiber access alone may meet the demand or whether, given the state of the fiber access network across the entire neighborhood, it may be best to use a non-fiber access modality in addition to the fiber access network connection. In one example, the network performance level shortcoming may be determined via a forecasting model based upon at least the network performance information. For instance, as noted above, the network performance information may include past data utilization metrics for uplink and/or downlink, for different data types and/or different applications or application types, etc., the number of connected devices (e.g., at different times of the day, days of the week, etc., which may be used for forecasting future demand at similar times of the day, days of the week, etc.), and so forth. In one example, the network performance level shortcoming is determined via the forecasting model further based on network performance information from other subscriber premises sharing a same fiber access network associated with the fiber access network connection of the converged access device.

At step 330, the processing system selects a network access modality distribution for implementation by the converged access device, in response to the determining of the network performance level shortcoming. For instance, in one example, the network access modality distribution may be selected in accordance with a rule set defined by the communication network and provided to the processing system. In one example, the selecting of the network access modality distribution may be via a converged service management model comprising a machine learning model that is configured to generate an output comprising the network access modality distribution for the converged access device in response to an input vector comprising at least the network performance information from the converged access device. In one example, the input vector may further include network performance information from other subscriber premises, such as may be obtained at step 310. In one example, the input vector may further include one or more of: a time of day, a day of the week, an indicator of a holiday, an indicator of a mass gathering event associated with an area of the converged access device, etc. In this regard, it should be noted that the processing system may implement a same or similar converged service management model such as described above with respect to the example method 200 of FIG. 2 (e.g., comprising a rule set and/or one or more MLMs for selecting a network access modality distribution and/or for forecasting/prediction that a SLA may not be met, etc.).

At optional step 340, the processing system may implement the network access modality distribution that is selected. For instance, the processing system (e.g., the converged access device) may transmit and/or receive data via the respective network access modalities. In one example, this may include the processing system/CAD establishing a wireless network access session, e.g., a radio resource control (RRC) attach procedure to establish a cellular and/or FWB network connection, or the like.

At step 350, the processing system transmits to the communication network, e.g., to a network-based premises management and monitoring system, an indication (e.g., a notification or information pertaining to the specific parameters of the selected network access modality distribution) of the network access modality distribution that is selected for implementation by the converged access device (e.g., which may be implemented at optional step 340 and/or which may be requested to be implemented by the converged access device via the present step 350). For instance, the network-based premises management and monitoring system and the converged access device may maintain communications on an ongoing basis (e.g., via the wired/fiber access modality or otherwise) to report network performance information, to transmit and receive network access modality distributions for implementation by the converged access device, to request and obtain approvals, denials, modifications, and so forth.

At optional step 360, the processing system may obtain from the communication network, an instruction altering the network access modality distribution for implementation by the converged access device. For instance, prior to or after implementing the network access modality distribution, the processing system may obtain from the communication network (e.g., the network-based premises management and monitoring system), an instruction altering the network access modality distribution for implementation by the converged access device (e.g., by the processing system). In other examples, the communication network may approve the network access modality distribution as requested by the processing system, or may deny the request (e.g., instructing the processing system to maintain a current/prior network access modality distribution).

At optional step 370, the processing system may implement the network access modality distribution that is altered in accordance with the instruction. In other words, in one example, the processing system may select an initial preferred network access modality distribution, where the communication network may approve, deny, or modify the network access modality distribution, e.g., using the same or similar logic as described above in connection with the example method 200 of FIG. 2.

Following step 350 or one of the optional steps 360 or 370, the method 300 may proceed to step 395. At step 395 the method 300 ends.

It should be noted that the method 300 may be expanded to include additional steps, or may be modified to replace steps with different steps, to combine steps, to omit steps, to perform steps in a different order, and so forth. For instance, in one example the processing system may repeat one or more steps of the method 300, such as steps 310-350 or steps 310-370 on a periodic basis, in response to requests from the communication network to re-evaluate a network access modality distribution, and so forth. In one example, step 350 may precede optional step 340. In one example, step 350 may be omitted. For instance, the communication network may periodically or otherwise provide updates to the converged service management model and/or rules set(s) for implementation by the processing system/converged access device (and similarly for other converged access devices), where the converged access devices are expected to operate within the bounds of these rules/models. In one example, steps 320 and 330 may be combined. For example, the determination of a SLA shortcoming may be an inherent/latent function of the converged service management model that may generate output network access modality distributions in response to input network performance data. In one example, the method 300 may further include creating one or more training data sets from the network performance data of the converged access device and/or from a plurality of converged access devices (e.g., in a same neighborhood, or the like), and training one or more machine learning models for a converged service management model as described above using the training data set(s).

In one example, the method 300 may alternatively comprise a processing system of a converged access device monitoring/collecting network performance information associated with the converged access device, transmitting, to the communication network, the network performance information, obtaining, from the communication network, a network access modality distribution for implementation by the converged access device, and implementing the network access modality distribution that is selected. For instance, in such an example, the converged access device may not include selection logic of its own, or may operate in a mode where such functionality is disabled or overridden, and where decision making for the network access modality distribution to be used is deferred to the communication network in the first instance, e.g., without recommendation or specific request by the converged access device for a preferred distribution mode. In one example, the method 300 may be expanded or modified to include steps, functions, and/or operations, or other features described above in connection with the example(s) of FIG. 1 and/or FIG. 2, or as described elsewhere herein. Thus, these and other modifications are all contemplated within the scope of the present disclosure.

In addition, although not expressly specified above, one or more steps of the example method 200 or the example method 300 may include a storing, displaying and/or outputting step as required for a particular application. In other words, any data, records, fields, and/or intermediate results discussed in the respective methods can be stored, displayed and/or outputted to another device as required for a particular application. Furthermore, operations, steps, or blocks in FIG. 2 or FIG. 3 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the example embodiments of the present disclosure.

FIG. 4 depicts a high-level block diagram of a computing system 400 (e.g., a computing device or processing system) specifically programmed to perform the functions described herein. For example, any one or more components or devices illustrated in FIG. 1, or described in connection with FIG. 2 or FIG. 3 may be implemented as the computing system 400. As depicted in FIG. 4, the computing system 400 comprises a hardware processor element 402 (e.g., comprising one or more hardware processors, which may include one or more microprocessor(s), one or more central processing units (CPUs), and/or the like, where the hardware processor element 402 may also represent one example of a “processing system” as referred to herein), a memory 404, (e.g., random access memory (RAM), read only memory (ROM), a disk drive, an optical drive, a magnetic drive, and/or a Universal Serial Bus (USB) drive), a module 405 for determining a network access modality distribution for a converged access device via a converged service management model in accordance with network performance information from the converged access device and/or for selecting a network access modality distribution for implementation by a converged access device in response to a determination of a network performance level shortcoming, and various input/output devices 406, e.g., a camera, a video camera, storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like).

Although only one hardware processor element 402 is shown, the computing system 400 may employ a plurality of hardware processor elements. Furthermore, although only one computing device is shown in FIG. 4, if the method(s) as discussed above is implemented in a distributed or parallel manner for a particular illustrative example, e.g., the steps of the above method(s) or the entire method(s) are implemented across multiple or parallel computing devices, then the computing system 400 of FIG. 4 may represent each of those multiple or parallel computing devices. Furthermore, one or more hardware processor elements (e.g., hardware processor element 402) can be utilized in supporting a virtualized or shared computing environment. The virtualized computing environment may support one or more virtual machines which may be configured to operate as computers, servers, or other computing devices. In such virtualized virtual machines, hardware components such as hardware processors and computer-readable storage devices may be virtualized or logically represented. The hardware processor element 402 can also be configured or programmed to cause other devices to perform one or more operations as discussed above. In other words, the hardware processor element 402 may serve the function of a central controller directing other devices to perform the one or more operations as discussed above.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a computing device, or any other hardware equivalents, e.g., computer-readable instructions pertaining to the method(s) discussed above can be used to configure one or more hardware processor elements to perform the steps, functions and/or operations of the above disclosed method(s). In one example, instructions and data for the present module 405 for determining a network access modality distribution for a converged access device via a converged service management model in accordance with network performance information from the converged access device and/or for selecting a network access modality distribution for implementation by a converged access device in response to a determination of a network performance level shortcoming (e.g., a software program comprising computer-executable instructions) can be loaded into memory 404 and executed by hardware processor element 402 to implement the steps, functions or operations as discussed above in connection with the example method(s). Furthermore, when a hardware processor element executes instructions to perform operations, this could include the hardware processor element performing the operations directly and/or facilitating, directing, or cooperating with one or more additional hardware devices or components (e.g., a co-processor and the like) to perform the operations.

The processor (e.g., hardware processor element 402) executing the computer-readable instructions relating to the above described method(s) can be perceived as a programmed processor or a specialized processor. As such, the present module 405 for determining a network access modality distribution for a converged access device via a converged service management model in accordance with network performance information from the converged access device and/or for selecting a network access modality distribution for implementation by a converged access device in response to a determination of a network performance level shortcoming (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium may comprise a physical device, a hardware device, or a device that is discernible by the touch. More specifically, the computer-readable storage device or medium may comprise any physical devices that provide the ability to store information such as instructions and/or data to be accessed by a processor or a computing device such as a computer or an application server.

While various examples have been described above, it should be understood that they have been presented by way of example only, and not limitation. Thus, the breadth and scope of a preferred example should not be limited by any of the above-described examples, but should be defined only in accordance with the following claims and their equivalents.

What is claimed is:

1. A method comprising:
obtaining, by a processing system including at least one processor, network performance information from a converged access device, wherein the converged access device is capable of a fiber access network connection to a communication network and at least one type of wireless access network connection to the communication network;
determining, by the processing system via a converged service management model in accordance with the network performance information from the converged access device, a network access modality distribution for the converged access device; and
transmitting, by the processing system to the converged access device, the network access modality distribution for implementation by the converged access device.

2. The method of claim 1, wherein the at least one type of wireless access network connection comprises at least one of:
a cellular access network connection; or
a fixed wireless broadband connection.

3. The method of claim 1, wherein the network access modality distribution includes utilizations of both the fiber access network connection and the at least one type of wireless access network connection.

4. The method of claim 3, wherein the network access modality distribution includes a first percentage of data traffic of the converged access device to be allocated to the fiber access network connection and a second percentage of the data traffic of the converged access device to be allocated to the at least one type of wireless access network connection.

5. The method of claim 3, wherein the network access modality distribution includes a first type of data traffic of the converged access device to be allocated to the fiber access network connection and a second type of data traffic of the converged access device to be allocated to the at least one type of wireless access network connection.

6. The method of claim 1, wherein the converged access device is deployed at a subscriber premises, wherein the fiber access network connection comprises one of:
a fiber-to-the-premises connection,
a fiber-to-the-curb connection, or
a fiber-to-the-node connection.

7. The method of claim 1, wherein the converged service management model comprises a rule set that indicates a method to allocate all data traffic of the converged access device to the fiber access network connection when a data traffic demand of the converged access device is below a threshold, and to allocate a first percentage of the data traffic of the converged access device to the fiber access network connection and a second percentage of the data traffic of the converged access device to the at least one type of wireless access network connection when the data traffic demand of the converged access device is at or above the threshold.

8. The method of claim 1, wherein the converged service management model comprises a rule set that indicates a method to allocate all data traffic of the converged access device to the fiber access network connection when a data traffic demand of the converged access device is below a threshold, and to allocate a first type of data traffic of the converged access device to the fiber access network connection and a second type of data traffic of the converged access device to the at least one type of wireless access network connection when the data traffic demand of the converged access device is at or above the threshold.

9. The method of claim 1, wherein the converged service management model comprises a machine learning model that is configured to generate an output comprising the network access modality distribution for the converged access device in response to an input vector comprising at least the network performance information from the converged access device.

10. The method of claim 9, wherein the input vector further comprises at least one of:
network performance information from other subscriber premises sharing a same fiber access network associated with the fiber access network connection of the converged access device;
a time of day;
a day of the week;
an indicator of a holiday; or
an indicator of a mass gathering event associated with an area of the converged access device.

11. The method of claim 1, wherein at least one of:
the network performance information comprises a data traffic demand; or
the data traffic demand is predicted from the network performance information.

12. The method of claim 1, further comprising at least of:
activating at least one sector of at least one cellular access point in response to the determining of the network access modality distribution for the converged access device; or
adjusting a beam of the at least one sector of the at least one cellular access point in response to the determining of the network access modality distribution for the converged access device.

13. A non-transitory computer-readable medium storing instructions that, when executed by a processing system including at least one processor, cause the processing system to perform operations, the operations comprising:
obtaining network performance information from a converged access device, wherein the converged access device is capable of a fiber access network connection to a communication network and at least one type of wireless access network connection to the communication network;
determining, via a converged service management model in accordance with the network performance information from the converged access device, a network access modality distribution for the converged access device; and
transmitting, to the converged access device, the network access modality distribution for implementation by the converged access device.

14. A method comprising:
monitoring, by a processing system including at least one processor of a converged access device, network performance information associated with the converged access device, wherein the converged access device is capable of a fiber access network connection to a communication network and at least one type of wireless access network connection to the communication network;
determining, by the processing system, a network performance level shortcoming in accordance with the network performance information;
selecting, by the processing system, a network access modality distribution for implementation by the converged access device, in response to the determining of the network performance level shortcoming, wherein the network access modality distribution includes at least a first portion of data traffic of the converged access device being allocated to the fiber access network connection and at least a second portion of the data traffic of the converged access device being allocated to the at least one type of wireless access network connection; and
transmitting, by the processing system to the communication network, an indication of the network access modality distribution that is selected for implementation by the converged access device.

15. The method of claim 14, further comprising:
implementing, by the processing system, the network access modality distribution that is selected.

16. The method of claim 14, wherein the network access modality distribution is selected in accordance with a rule set defined by the communication network and provided to the processing system.

17. The method of claim 14, further comprising:
obtaining, by the processing system, from the communication network, an instruction altering the network access modality distribution that is selected for implementation by the converged access device; and
implementing, by the processing system, the network access modality distribution that is altered in accordance with the instruction.

18. The method of claim 14, wherein the network performance level shortcoming is determined via a forecasting model based upon at least the network performance information.

19. The method of claim 18, wherein the network performance level shortcoming is determined via the forecasting model further based on network performance information from other subscriber premises sharing a same fiber access network associated with the fiber access network connection of the converged access device.

20. The method of claim 14, wherein the selecting of the network access modality distribution is via a converged service management model comprising a machine learning model that is configured to generate an output comprising the network access modality distribution that is selected for the converged access device in response to an input vector comprising at least the network performance information from the converged access device.
